(19) United States
(12) Patent Application Publication
(10) Pub. No.: US 2007/0026803 A1
(43) Pub. Date: Feb. 1, 2007

(54) Method and apparatus for link adaptation

(76) Inventor: Peter Malm, Lund (SE)

Correspondence Address: POTOMAC PATENT GROUP, PLLC, P. O. BOX 270, FREDERICKSBURG, VA, 22404, US

(21) Appl. No.: 10/549,694

(22) PCT Filed: Mar. 15, 2004
(86) PCT No.: PCT/EP04/02651

§ 371 Date: Jun. 24, 2006

Related U.S. Application Data
(60) Provisional application No. 60/457,556, filed on Mar. 26, 2003.

(30) Foreign Application Priority Data
Mar. 21, 2003 (EP) 03006418.2

(51) Int. Cl. H04B 1/00

(52) U.S. Cl. 455/63.1; 455/67.11; 455/67.13

(57) ABSTRACT

A method and apparatus for providing a link quality report in a wireless communication system supporting link adaptation. An input signal carrying data blocks in one or several transmission intervals of a reporting interval is received by a receiver of the apparatus. A quality measurement unit provides a link quality measure of the current reporting interval. A correction unit corrects the link quality measure by determining a SIR loss of the link, which is induced by unmatched transmission parameter settings of a physical layer. Then, a link quality report for the current reporting interval is based on the corrected link quality measure and transmitted by the transmitter to the transmitting unit, which will adapt the setting of physical layer parameters accordingly.

### TECHNICAL FIELD OF THE INVENTION

The present invention relates to the field of communication systems wherein adaptation of transmission parameters is provided over time. More specifically, the invention relates to a method and an apparatus used in a communication system for optimizing the link performance between unmatched transmitter and receiver units when a link quality report is utilized for the adaptation process.

### DESCRIPTION OF RELATED ART

In wireless communication systems, such as mobile telecommunications systems, a transmitter unit, e.g. a base station, communicates data packets and voice to a receiver unit, e.g. a portable radio communication apparatus such as a mobile radio terminal, a mobile telephone, a pager, a communicator, i.e. an electronic organizer, a smart phone or the like. In many communication systems, link adaptation, or adaptive modulation, is an established technique to adapt physical layer (L1) transmission parameters to the changing characteristics of a radio channel of the communication system. A typical radio link exhibits e.g. fading and interference, which results in a signal-to-interference ratio (SIR) level that changes with time. Two different design strategies exist to handle the changing SIR. Firstly, power control is preferably used in scenarios where the link quality needs to be constant over time, such as for voice communication. Secondly, link adaptation is preferred for packet data transmission where the link quality may be allowed to change over time, such as GSM/EGPRS (General System for Mobile communication/Enhance General Packet Radio Service) and UMTS/HS-DSCH (Universal Mobile Telecommunications System/High Speed Downlink Shared CHannel).

In a communication system using link adaptation, the transmitting unit (Tx-unit) and the receiving unit (Rx-unit) may have unmatched characteristics. The term unmatched is used herein to denote when a transmitter does not have full knowledge of the error sensitivity of the receiver with respect to changes in the various L1 transmission parameters that are used in the link adaptation process, such as modulation type, code rate, and bandwidth. Discrepancies between adaptation parameter settings relating to a certain link quality at the Tx-unit and the Rx-unit, respectively, may lead to a SIR loss and a crippled performance gain of advanced receiver structures, which are meant to improve the peak rate of the receiver. Link adaptation systems are best effort systems, and unmatched Tx-/Rx-unit characteristics lead to non-optimum performance, which may be directly reflected on the experienced peak rate.

The inherent problem with all link adaptation systems is how the Tx-unit should be aware of in what way the Rx-unit experiences the radio link quality. Feeding back information about the link quality, which is utilized by the Tx-unit to choose transmission parameter settings, often solves this problem. This approach is used in both GSM/EGPRS and UMTS/HS-DSCH. Presently, there are two different solutions with regard to what type of information that should be fed back in the link quality report: a SIR feedback or a requested transport-format and resource combination (TFRC) feedback. A third alternative, used in GSM/EGPRS is when raw-bit error probability (BEP) is fed back to the Tx-unit, which can be considered as a filtered SIR feedback.

In case a SIR estimate is fed back to the Tx-unit, the Tx-unit knows which actual SIR, possibly affected by receiver enhancements if applicable, the Rx-unit experiences. However, the Tx-unit does not know which TFRC it should use to optimize the link performance since the receiver characteristics known to the Tx-unit and the actual receiver characteristics of the Rx-unit might not necessarily be the same, since a particular receiver's characteristics usually is not known at the Tx-unit. The reason for this is that receiver enhancements are vendor specific features, which may be introduced over time, and it is not likely that all Tx-units already deployed can be updated with receiver characteristics from each and every vendor.

In case a TFRC indicator is reported instead of a SIR value, the situation is somewhat different in the Tx-unit. When the Tx-unit receives a requested TFRC from the Rx-unit in reporting interval n, the Tx-unit may optimize the link throughput by using exactly the requested TFRC in the coming transmission. However, it is not certain that the requested TFRC matches the actual transport need. Hence the Tx-unit is faced with a TFRC selection problem: the Tx-unit chooses the TFRC that best matches the reported TFRC indicator with respect to SIR. The block size N is also taken into consideration before choosing TFRC. However, it is not certain that the Tx-unit chooses the optimum TFRC for each particular Rx BLER (BLock Error Ratio) characteristic.

Consequently, there is a problem in that the Tx-unit needs to know the optimum physical-layer parameters of a certain Rx-unit for each particular physical channel state and user data size to optimize the link quality. However, the physical channel state resides in the Rx-unit while the information about the amount of user data resides in the Tx-unit. An optimum link adaptation system would therefore have to first send the information about the amount of user data to the Rx-unit, which then reports the best possible TFRC for that amount of user data and for the current channel state back to the Tx-unit. This optimization procedure would result in an extensive overhead and delay. There is a need for a system that optimizes the link throughput without introducing any new components in the transmitting unit, and that adapts to changes of the receiver characteristics of the receiving unit.

US-2002/0110088 discloses a link adaptation system, which is capable of fast adaptation. The system can follow the quality of the downlink very rapidly. However, the system requires two uplink channels for the link quality report, one channel for full quality reports at a slightly lower rate and one channel for fast updates indicating relative changes of the link quality to take care of unmatched transmitter and receiver characteristics. As two different quality reports are transmitted over different channels, this technique requires modifications of an existing communications system wherein only one channel is dedicated for the link quality report. Also, the base station has to be modified to be able to determine the required change of the transmitter settings, which is determined based on the full and the updated link quality reports. Consequently, it is not possible to implement the updates in an existing system, which only has one channel for the link quality report. Another disadvantage with this system is that it is only possible to indicate the direction of a change of the link quality and not the actual change.

### SUMMARY OF THE INVENTION

One object of the present invention is to provide a method for providing a link quality measure of a downlink of a communication system comprising at least one transmitting unit (Tx-unit) and one receiving unit (Rx-unit), the communication system featuring link adaptation wherein one uplink channel is utilized for providing a link quality report to optimize the link performance, and the receiver characteristics of the Rx-unit to optimize the link throughput.

According to the invention, this object is achieved by a method wherein the link quality measure is corrected before being used for providing a link quality report. According to the method, a link quality measure, such as a signal-to-interference ratio (SIR) of a communication link, is obtained for a current reporting interval. The link quality measure is then corrected for SIR losses, which are induced by unmatched transmission parameter (TP) settings of the Tx-unit and the Rx-unit. The content of the link quality report of the current reporting interval will then be based on the corrected link quality measure. The transmitting unit will adjust its transmission parameters according to the link quality report. Therefore, the transmissions will be adjusted according to the optimal setting with regard to the receiver characteristics.

According to one aspect of the invention, in a first embodiment, SIR reporting is utilized for the link quality report. The link quality measure is a SIR, which is corrected with a SIR value. The corrected SIR is then incorporated in the link quality report that is transmitted to the transmitting unit. The value of the link quality report could indicate desired TP settings of the physical layer (L1) that will better achieve a block error rate (BLER) target of the receiver than the TP settings used for the previous reporting interval.

The information in the link quality report may be a requested TP indicator. A TP indicator corresponding to the corrected link quality measure is comprised in the link quality report indicating a desired transmission parameter setting of the transmitting unit. The corrected link quality measure may be mapped against stored indicators to provide a TP indicator, which is assumed to best meet a certain BLER target.

The link quality measure that formed basis of the content of the previous reporting interval and the current link quality measure of the current reporting interval may be filtered before being added to the current link quality measure. This will even further improve the accuracy of the corrected link quality measure. The filtering may be provided by averaging the discrepancy between the link quality measure that was utilized to provide the link quality report of the previous reporting interval and link quality measures of each of the transmission intervals of the current reporting interval. Then, the averaged discrepancy value will be added to the link quality measure of the present reporting interval.

Another object of the invention is to provide an electronic communication apparatus capable of producing a corrected link quality measure that is used to provide a link quality report over one channel to a transmitting unit. Moreover, it is an object that the link quality report will carry information that will optimize the link performance of a communication link between a transmitting unit and the apparatus, so that the transmitting unit does not need to have full knowledge of the receiver characteristics of the apparatus.

According to a second aspect of the invention, this object is achieved by an electronic communication apparatus comprising a receiver, a quality measuring unit, a memory, and a correction unit. Further, the apparatus is adapted to determine the transmission parameter setting induced SIR losses. Also the apparatus is adapted to correct the current link quality measure based on said losses to provide a corrected link quality measure.

The apparatus may be adapted to provide a link quality report based on the corrected link quality measure. The apparatus is in one embodiment adapted to incorporate a SIR value into the link quality report, said SIR value corresponds to the corrected link quality measure. In another embodiment, the apparatus is adapted to incorporate a TP indicator corresponding to the corrected link quality measure into the link quality report.

According to a third aspect of the invention, a computer software product is provided, which comprises software code portions for performing the method according to the invention when said product is run by a mobile terminal having digital computer capabilities.

One advantage of the present invention is that the Tx-unit does not need to have full knowledge of the receiver characteristics of the Rx-unit. Also, the link quality report may be transmitted over only one control channel and yet optimize the link performance. Also, it is possible to introduce other receiver characteristics of the Rx-unit without updating the Tx-unit, as all corrections of the link quality measure is made at the receiving unit. Also, one Tx-unit may serve several Rx-units having different receiver characteristics with optimized performance although the Tx-unit does not have full knowledge of the characteristics of any of the receivers.

Further preferred embodiments of the invention are defined in the dependent claims.

It should be emphasized that the term “comprises/comprising ” when used in this specification is taken to specify the presence of stated features, integers, steps or components but does not preclude the presence or addition of one or more other features, integers, steps, components or groups thereof.

### BRIEF DESCRIPTION OF THE DRAWINGS

Further objects, features, and advantages of the invention will appear from the following description of several embodiments of the invention, wherein various features of the invention will be described in more detail with reference to the accompanying drawings, in which:

FIG. 1 is a block diagram of a communication system employing link adaptation according to the present invention, and a front view of two mobile telephones;

FIG. 2 is a block diagram of the mobile telephone of FIG. 1 showing components for providing a corrected link quality measure;

FIG. 3a is a BLER versus SIR diagram for SIR reporting;

FIG. 3b is a BLER versus SIR diagram for TFRC reporting;

FIG. 4 is a table of possible link adaptation parameters according to an exemplary embodiment of the invention;

FIGS. 5a and 5b are a flowchart of the steps according to a first embodiment of the invention, wherein SIR reporting is utilized; and

FIGS. 6a and 6b are a flowchart of the steps according to a second embodiment of the invention, wherein TFRC reporting is utilized; and

FIGS. 7a and 7b are a flowchart of the steps according to a third embodiment of the invention, wherein TFRC reporting is utilized.

### DETAILED DESCRIPTION OF EMBODIMENTS

In a packet-switched data communication system, a link quality measure of a communication link between a transmitting unit (Tx-unit) and a receiving unit (Rx-unit) provides valuable information to the Tx-unit in determining the proper settings of the physical layer (L1) transmission parameters, such as data rate, encoding, modulation and scheduling of data communications. To provide as high performance as possible, it is beneficial to provide the quality measure efficiently and accurately from the receiver unit (Rx-unit) to the transmitter unit (Tx-unit). According to the present invention, the link quality measure as determined by the Rx-unit is corrected or adjusted for SIR losses induced by unmatched Tx-unit and Rx-unit transmission parameter settings before reported to the Tx-unit, wherein the link quality measure will provide for a better performance of the link throughput.

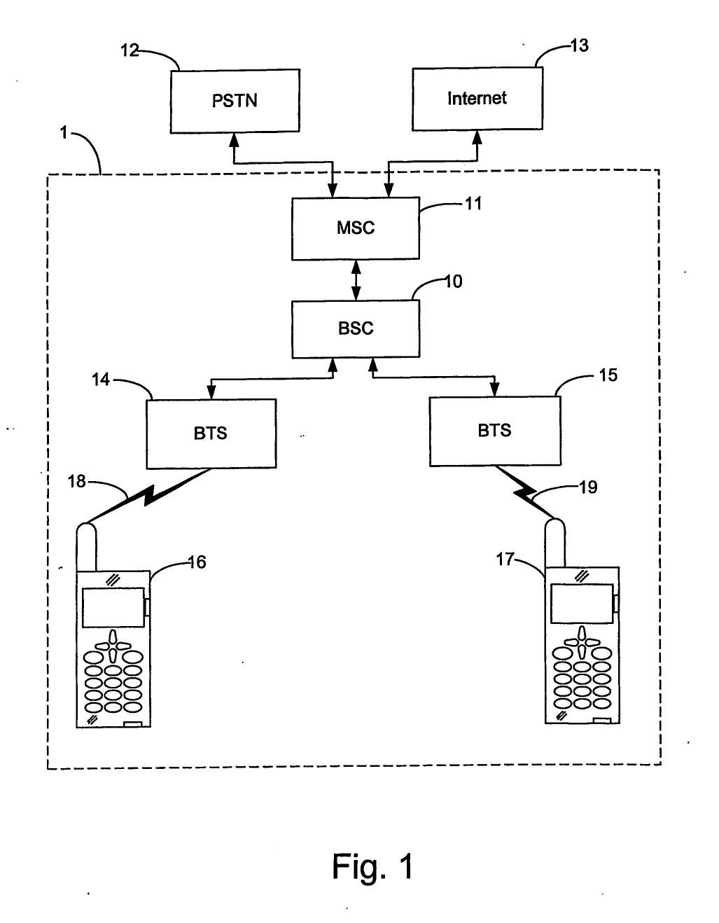

FIG. 1 discloses an exemplary communication system 1, wherein the present invention for providing a corrected link quality measure is used. The communication system 1 is a UMTS/HS-DSCH telecommunication system. However, other communication systems utilizing link adaptation are equally possible within the scope of the invention, such as GSM/EGPRS. In spread spectrum wireless communication systems, link adaptation is controlled by the quality of a communication downlink, wherein a signal-to-interference ratio (SIR) estimate of a pilot channel, such as the CPICH channel in UMTS, provides a quality measure for evaluating the link.

The communication system 1 comprises a base station controller 10 (BSC) connected to a mobile switching center (MSC) 11. The MCS 11 may also be operatively connected to a public switched telephone network (PSTN) 12, and a wired communication system 13, such as the Internet. The BSC 10 is also connected to at least one base transceiver station (BTS) 14, 15 each being connectible to one or several mobile terminals 16, 17 over a wireless interface 18, 19. Mobile terminal as used herein comprises, but is not limited to, a radio terminal, a mobile telephone, a pager, or a communicator, i.e. a personal digital assistant, a smartphone or the like. In FIG. 1, the mobile terminals are embodied as mobile telephones 18, 19.

The MSC 11 is the interface between the wireless communication system 1 and the wired subsystems 12, 13. The BSC 10 is the control and management system for one or several BTS 14, 15. The BSC 10 exchanges messages with the BTS 14, 15 and the MSC 11. Each of the BTS 16, 17 consists of transceivers placed at a single location.

The wireless interface 18, 19 includes radio air interface physical channels between the BTS 14, 15 and the mobile terminals 16, 17, including but not limited to a pilot channel or embedded pilot symbols and a data channel. The physical channels 18, 19 are communication paths described in terms of the digital coding and RF (radio frequency) characteristics for the downlink and the uplink.

When used in this description Tx-unit means the transmitting unit, such as the BTS 14, 15 controlled by the BCS 10, and Rx-unit means the receiving unit, such as any of the mobile terminals 16, 17, if not otherwise stated.

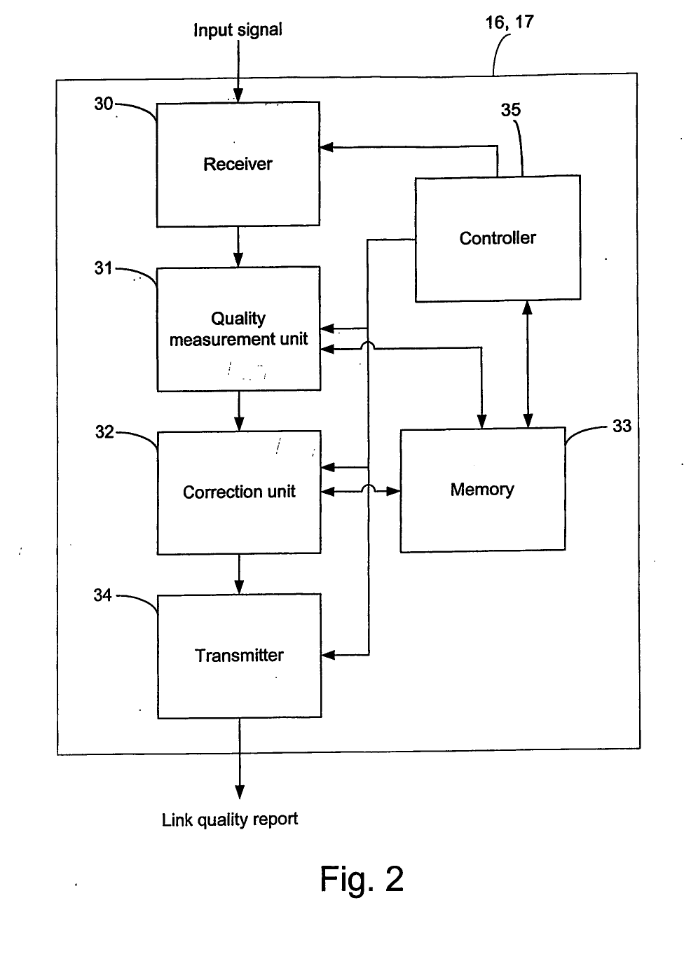

FIG. 2 discloses the mobile terminal 16, 17, comprising a digital receiver 30, which is adapted to processes signals received over the wireless interface 18, 19. The receiver 30 is connected to a quality measurement unit 31, that is adapted to provide a link quality measure as will be further described below. The measurement unit 31 is connected to a correction unit 32, which according to the invention is adapted to correct or adjust the current link quality measure before said measure is utilized to form the link quality report. The correction unit 32 and the measurement unit 31 are connected to a memory 33, wherein a look-up table for storing indicators relating to a certain transmission parameter (TP) setting, such as transport format and resource allocation combination (TFRC) indicators or channel quality indicators (CQI), is stored together with corresponding link quality measures, such as SIR values. The memory 33 is implemented as a combined random access memory (RAM) and a read only memory (ROM). Other memories are also possible in other embodiments of the invention, such as a non-volatile memory. The correction unit 32 is also connected to a transmitter 34 adapted to transmit a link quality report, based on the corrected link quality measure when appropriate, over a control channel to the Tx-unit. A controller 35, such as an integrated circuit of the mobile terminal 16, 17, is connected to the receiver 30, the quality measurement unit 31, the correction unit 32, and the memory 33 to control the operation of said units. Alternatively, a central processing unit (CPU) of the mobile terminal 16, 17 may provide the functionality of the controller 35.

Link quality reports are fed back to the Tx-unit from the Rx-unit over e.g. an up-link control channel. According to the invention, either signal-to-interference (SIR) feedback (or carrier to interference), such as a SIR value, or requested TFRC feedback, such as a TFRC indicator indicating a desired TP setting of the Tx-unit, can be utilized. However, other link quality reports may also be utilized within the scope of the invention, such as e.g. a channel quality indicator (CQI) relating to a certain TFRC.

According to the present invention, different TFRC mappings may be utilized in the communication system, one in the Tx-unit and one in the Rx-unit for interpreting the reported link quality and the measured link quality, respectively. Tx mapping is used by the Tx-unit to find a suitable TFRC setting for transmission of data packets to the Rx-unit, which corresponds as closely as possible to the requested TFRC setting. Rx mapping is used by the Rx-unit in case a required TFRC indicator shall be reported to the Tx-unit. As the Tx and Rx mappings are unmatched, this may lead to SIR losses, which according to the invention may be detected or estimated and compensated for at the Rx-unit.

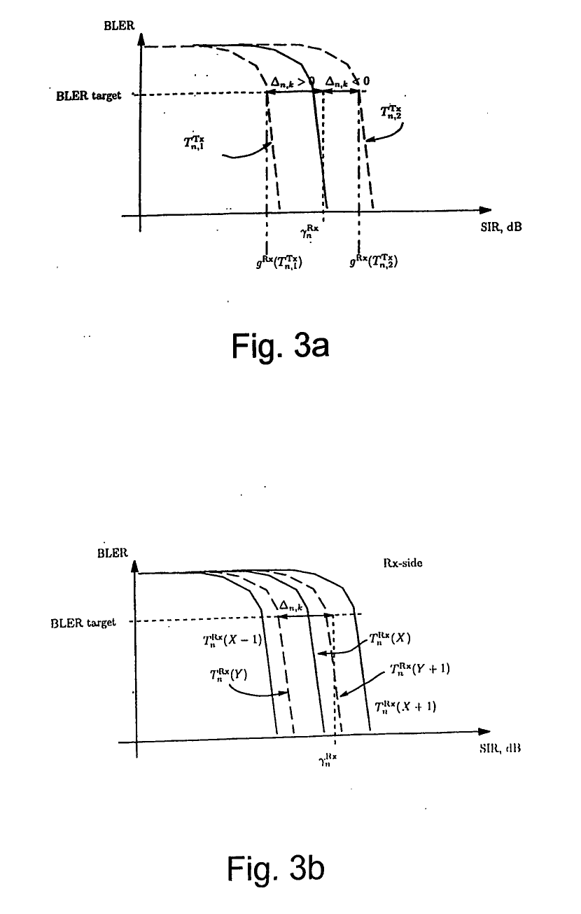

FIG. 3a illustrates a BLER versus SIR diagram for the Rx-unit when SIR reporting is utilized. The solid line corresponds to the best TFRC according to the Rx-unit that fulfills the BLER target with the user data size used by the Tx-unit. γₙ^{Rx} is the reported SIR value for reporting interval n, which indicates a desired TP setting. The BLER target may be set differently for each Rx-unit, and may be transmitted by the Tx-unit to the Rx-unit. Furthermore, T_{n,1}^{Tx} and T_{n,2}^{Tx} correspond to two different TFRCs that the Tx-unit may use with the same user data size, which according to a look-up table stored at the Tx-unit matches the SIR value reported by the Rx-unit. If TFRC setting T_{n,1}^{Tx} is used by the Tx-unit, then the SIR value at the Rx-unit is underestimated by the Tx-unit in the case illustrated in FIG. 3a. It is not likely that the Tx-unit chooses a TFRC so that the SIR loss or discrepancy value, Δ_{n,k}, at the Rx-unit for a certain reporting interval n is Δₙ<0, but it may occur due to error events inflicted by the physical radio channel or differences between Tx-unit and Rx-unit BLER characteristics.

FIG. 3b illustrates a BLER versus SIR diagram for the Rx-unit when TFRC reporting is utilized, wherein the reported TFRC indicator results in a SIR loss. The SIR γₙ^{Rx} estimated by the Rx-unit together with the BLER target implies that TFRC Tₙ^{Rx}(X) is optimum in the Rx-unit. Hence, Tₙ^{Rx}(X) is reported back to the Tx-unit. It is not certain that the Tx-unit can use Tₙ^{Rx}(X) directly because the user data size may be different. Therefore, the Tx-unit finds the closest TFRC, Tₙ^{Tx}(Y) corresponding to TFRC Tₙ^{Rx}(Y) at the Rx-unit, with less or equal BLER, which can carry the user data size. The unmatched physical layer transmission parameter settings of the Tx-unit and the Rx-unit cause a SIR-loss Δ_{n,k} at the Rx-unit compared to the estimated SIR γₙ^{Rx}. Moreover, FIG. 3b illustrates a case where even the next higher TFRC, Tₙ^{Rx}(Y+1), could be used.

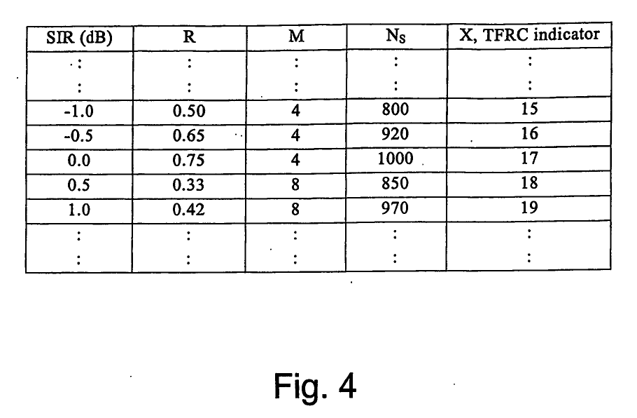

The table of FIG. 4 discloses an example of transmission parameter settings of the Tx-unit. The parameter settings are e.g. the modulation alphabet size M, code rate R, and number of symbols per transmission interval Nₛ. In this embodiment, the TFRC consists of these three parameters. However, these parameters are merely exemplary. Other parameters such as default power, code channel power offset etc can also be included in other embodiments, as will be explained below. In TFRC reporting, each of the Tx-unit and the Rx-unit has such a table, which are not necessarily the same. The code block size depends on the user data rate, i.e. how many user data bits that are encoded into a code block and transmitted in each transmission interval. Since the number of user data bits transmitted in each transmission interval depends on the available radio resource, i.e. the bandwidth or the code resource, the radio resource is included in the TFRC as the number of radio symbols Nₛ that may be transmitted per transmission interval.

TFRC-to-SIR tables, such as the look-up table illustrated in FIG. 4 can be regarded as functions from SIR to TFRC, or vice versa. Two conversion functions f and g is used below to denote the conversion of a SIR value to a TFRC, or vice versa:

f: SIR to TFRC

g: TFRC to SIR

The conversions can be performed in either the Tx-unit or the Rx-unit. As the the Tx-unit mapping may be different from the Rx-unit mapping, f^{Tx} and g^{Tx} relate to the conversion in the Tx-unit, and f^{Rx} and g^{Rx} relate to the conversion in the Rx-unit.

Furthermore, f is not bijective, i.e. one SIR value may map to several different TFRCs. The f function can take more than one argument. For example, both the reported SIR value, and the user data size Nₛ determined by the actual data size to be transmitted and by the available bandwidth, can be used by the Tx-unit when it selects a suitable TFRC. Hence, in this case f utilizes two entries for addressing the lookup table for retrieving a TFRC. A link adaptation system uses some kind of quantization of the parameters R, M, and Nₛ to minimize control signaling between the Tx-unit and the Rx-unit. Therefore, there is a finite number of TFRC indicators to tabulate performance for.

Regardless of whether SIR or TFRC reporting is utilized, an internal link quality estimate or measure is formed within the Rx-unit. For each reporting interval of a transmission session, the measurement unit 31 measures the SIR value of the pilot channel. For the first reporting interval, the SIR value (or a corresponding requested TFRC value) is reported back to the Tx-unit. The TFRC setting used by the Tx-unit based on the reported link quality measure for each transmission interval following the first link quality report of a transmission session is reported to the Rx-unit over the pilot channel. Hence, for each transmission interval k of a reporting interval n, where n>0, the Rx-unit knows the previously reported link quality measure indicating the desired TP setting and the TFRC used in the Tx-unit based on that link quality report, T_{n,k}^{Tx}. By knowing T_{n,k}^{Tx}, the controller 35 may determine the corresponding SIR value by mapping T_{n,k}^{Tx} against TFRC values stored in the memory 33. Consequently, after a time-period corresponding to the round trip time, the Rx-unit may determine the transmission parameter induced SIR loss or a discrepancy value for each transmission interval, Δ_{n,k}=γₙ^{Rx}−g^{Rx}(T_{n,k}^{Tx}), i.e. a SIR loss that is caused by the unmatched Tx-unit and Rx-unit transmission parameter settings. This simple comparison is possible if a scheduler of the Tx-unit follows the SIR that corresponds to either a directly reported SIR or an implicitly conveyed SIR (by a desired TFRC).

Alternatively, the controller 35 determines a filtered discrepancy value based on at least two discrepancy values Δ_{n,k} of a reporting interval before being utilized for determining the corrected link quality measure to increase the accuracy of the transmission.

One option to filter the discrepancy value is to average a number of the discrepancy values of the transmission intervals of one reporting interval, Δ_{n,k}, wherein k=1, 2 . . . N_{B}, and N_{B} is the number of transmission blocks, which are received during a reporting interval. Hence, the SIR value that was used for the previous reporting interval is retrieved from the memory 33 for determining a discrepancy value for each desired transmission interval of the reporting interval. If the number of transmission intervals during a reporting interval is for example four, each of the blocks of the transmission intervals are effected by the same link quality report and the discrepancy average could hence be formed over these four blocks since it is assumed that the TFRC may change on block-basis. More explicitly, the average discrepancy value is formed as:

$${\overline{Δ}}_{n} = \frac{1}{{N}_{B}} {\sum }_{k = 1}^{{N}_{B}} {Δ}_{n , k}$$

where Δ_{n,k} is determined as described above for the k:th block in a report cycle k=1,2, . . . , N_{B}. The filtered discrepancy value is then utilized by the correction unit 32 according to the same principles as described above to determined a corrected link quality measure, or:
γₙ₊₁^{Rx}=γ+ Δ̅ₙ,

where γ is the actually estimated link quality measure or SIR Value of the pilot channel in reporting interval n+1. The discrepancy value, or the filtered discrepancy value, may be utilized for the SIR reporting or TFRC reporting, as will be explained below. This embodiment of the filtering is useful when there is at least one larger TFRC, which fulfills the BLER target compared to the TFRC that was used in response to the SIR or TFRC indicator reported in reporting interval n. However, when there is no larger TFRC, more advanced filtering functions may have to be employed to further increase the accuracy of the compensation.

Alternatively, the discrepancy value is not filtered, wherein one of the discrepancy values for a transmission interval of a reporting interval may be used, preferably the last discrepancy value determined for the transmission interval. Also, more advanced filtering techniques are also possible.

According to a first embodiment of the invention, TFRC reporting is used. A TP indicator corresponding to a certain SIR value is reported back to the Tx-unit. For the first reporting interval of a transmission session, the measured SIR value is directly mapped against the look-up table comprising SIR values and corresponding TFRC indicators. The lookup-table may e.g. correspond to the table of FIG. 2 without the R and M columns, and be stored in the memory 33. The Rx mapping will convert the measured link quality measure for reporting interval n, such as the SIR value, to a TFRC indicator desired by the Rx-unit, or:
Tₙ^{Rx}=f^{Rx}(γₙ^{Rx}, N_{spec}).
The user data size Nₛ, which will be used by the Tx-unit in a future transmission, is not known by the Rx-unit. Therefore, a value N_{spec} is known beforehand to both the Rx-unit and the Tx-unit. The TFRC indicator, together with N_{spec} when appropriate, is for the first reporting interval transmitted to the Tx-unit without any correction.

When the Tx-unit receives the desired TFRC indicator, Tₙ^{Rx}, the Tx-unit will convert it into a SIR value in case the N_{spec} indicated by Tₙ^{Rx} does not match any actual data size that should be transmitted to the Rx-unit. The actual data size in the Tx-unit may be smaller or larger than N_{spec}. Hence the scheduler of the Tx-unit converts the received TFRC indicator to a SIR value, which together with the available user data size Nₛ are used as entries into the look-up table to retrieve a TFRC that matches the retrieved SIR, or:
Tₙ^{Tx}=f^{Tx}(g^{Tx}(Tₙ^{Rx}), Nₛ)
However, it may be the case that the TFRC requested by the Rx-unit matches the user data size. Then there is no need to convert Tₙ^{Rx} into a SIR value, as Tₙ^{Rx} indicate a user data size that matches the available user data size.

When the appropriate TFRC setting is chosen by the Tx-unit, the corresponding TFRC indicator will be transmitted to the Rx-unit, and the TFRC settings will be applied for the next data packet transmission interval over the data channel.

A SIR discrepancy or loss will be observed by the Rx-unit after a time period corresponding to the round trip time, as explained above. For reporting interval n+1, the quality measurement unit 31 of the mobile terminal 16, 17 will determine the SIR corresponding to the TFRC indicator received from the Tx-unit by mapping said indicator against the look-up table to retrieve the SIR corresponding to the TFRC setting actually used by the Tx-unit. Furthermore, each SIR value corresponding to a reported TFRC indicator is temporarily stored. Then the discrepancy value may be determined as discussed above, and it may also be determined whether the discrepancy value is Δₙ=0. If not, the Rx-unit may correct the link quality measure of the subsequent reporting interval n+1 to be mapped to a TFRC indicator, which will better achieve the BLER target.

To correct or adjust the link quality measure, the Rx-unit determines the discrepancy between the SIR value corresponding to the desired TFRC indicator, and the SIR value corresponding to the used TFRC setting in reporting interval n+1 in response to said reported TFRC indicator as described above, i.e.:
Δₙ=γₙ^{Rx}−γ,
wherein γₙ^{Rx} is the actual reported SIR value for reporting interval n in case of SIR reporting, and correspond to the TFRC indicator reported in reporting interval n in case of TFRC reporting, and where γ is the measured SIR on the data channel. To correct the link quality measure of reporting interval n+1, the discrepancy value, or the filtered discrepancy value when appropriate, is determined and used by the correction unit 32, or:
γₙ₊₁^{Rx}=γ+ Δ̅ₙ,
where γ is the SIR value measured for reporting interval n+1. Then, the corrected SIR value γₙ₊₁^{Rx} is used by the controller 35 to retrieve a corresponding TFRC indicator from the memory 33, which will form the corrected link quality measure for reporting interval n+1.

According to a second embodiment of the invention, a corrected SIR estimate forms the basis of the link quality report. The same principles as in the first embodiment are used. However, as SIR reporting is used, it is not necessary to retrieve any TFRC indicator corresponding to a SIR value from the look-up table. For the first reporting interval, the SIR value measured for the pilot channel is directly incorporated into the link quality report without any correction. However, in subsequent reporting intervals the measured SIR value is corrected by the determined discrepancy or filtered discrepancy as described above.

In SIR reporting, the Tx-unit may select the appropriate TFRC, Tₙ^{Tx}, by directly utilizing the reported γₙ^{Rx}, and Nₛ when appropriate, as entries for addressing a look-up table stored in a memory of the Tx-unit according to its own mapping:
Tₙ^{Tx}=f^{Tx}(γₙ^{Rx}, Nₛ)

After a time period corresponding to the round trip time, the Rx-unit received the TFRC indicator corresponding to the used TFRC setting, and may correct or adjust any subsequent link quality measure as described above.

According to a third embodiment of the invention, the Rx-unit will take care of SIR losses although the TFRC setting at the Tx-unit is not constant during a reporting interval. An advanced scheduler, e.g. as envisaged for UMTS/HS-DSCH, may change the transmission parameter settings and thus the SIR away from the SIR that corresponds to the desired value indicated in the link quality report in order to optimize the performance of the system. Such a scheduler may e.g. use a high code rate and increase the power in case there is a shortage of physical channels to obtain a high data rate. The advanced scheduler may also use a low code rate in case the power is limited but there are physical channels, i.e channelization codes in UMTS/HS-DSCH, available for use.

The link quality report of the third embodiment may either correspond to a TFRC indicator or a SIR value, according to the previous embodiments. For convenience, reference will only be made to a TFRC reporting below. The Tx-unit will receive a desired SIR target γₙ^{Tx}=γₙ^{Rx} directly, or as a desired TFRC γₙ^{Tx}=g^{Tx}(Tₙ^{Rx}). Furthermore, it is assumed that γₙ^{Tx} corresponds to the SIR on a common pilot channel, e.g. the CPICH in UMTS. Since there is some delay between the link quality report reporting instant and the instant that the link quality report is applied to the downlink, the smart scheduler may update the link quality report with downlink power control information in HS-DSCH during that delay. The power control operates on a considerably higher rate (once per slot) than the link quality reports (generally most frequently once per three slots). Therefore, an updated estimate, in transmission interval k after link quality report number n, of the SIR of the Rx-unit as estimated by the Tx-unit is:
γ_{n,k}^{Tx}=γₙ^{Tx}+δ_{PC}(n,k),
where δ_{PC}(n,k) is an accumulated power offset obtained from the downlink power control from time n, i.e. the reporting instant, to transmission interval k, i.e. the transmission interval when the value of the link quality report is applied. Here γ_{n,k}^{Tx}=γₙ^{Tx}=δ_{PC}(n,k) is regarded as the scheduler's estimate of what the Rx's CPICH will be for TI number k. The SIR of the CPICH channel is applied without any power correction. The scheduler of the Tx-unit adds a gain factor, δ_{HS}^{Tx}(n,k), (in dB) to adjust the SIR that is estimated taken the power control in consideration:
γ_{n,k}^{Tx}=γₙ^{Tx}+δ_{PC}(n,k)+δ_{HS}^{Tx}(n,k).

The adjusted SIR is then mapped by the Tx-unit to retrieve a TFRC setting, which is assumed to be more appropriate, or:
T_{n,k}^{Tx}=f^{Tx}(γₙ^{Tx}+δ_{PC}(n,k)+δ_{HS}^{Tx}(n,k)).

From the Rx-unit's point of view, this means that the reported TFRC can no longer be trusted, as the SIR value, on which the reported TFRC indicator is based, in transmission interval k is no longer known.

According to the third embodiment, the Rx-unit may estimate the TP setting induced SIR loss, i.e. the difference between the current link quality measure, γ_{n,k}^{Rx}, which in this embodiment is measured for the pilot channel in the k:th transmission interval after the n:th reporting interval, and the Rx-unit's estimate of which SIR that was the basis for the actually used TFRC in transmission interval k, T_{n,k}^{Tx}:
Δ_{n,k}=γ_{n,k}^{Rx}+δ_{HS}^{Rx}(n,k)−g^{Rx}(T_{n,k}^{Tx}),

where δ_{HS}^{Rx}(n,k) is the HS-DSCH power offset as estimated in the Rx-unit. This estimation may be provided by estimating the difference between the SIR of the pilot channel and the physical channel.

According to the same principles as the previous embodiments, a filtered discrepancy estimate may be determined before said discrepancy is being added to the SIR estimate between reporting interval n and n+1:
γₙ₊₁^{Rx}=γ+ Δ̅ₙ.

The corrected or adjusted SIR value may then be directly incorporated into the link quality report, or used for retrieving a corresponding TFRC indicator, as explained above.

The success of this procedure will depend on how well the Tx-unit estimates the Rx-unit's SIR at each time instant. In case the Tx-unit makes a bad estimate, e.g. due to bad downlink power control commands, or does not track the channel at all, then Δ_{n,k} may be rather large. Two cases may occur:

Δ_{n,k}>>0 dB: The Tx-unit has under estimated the Rx-unit's actual SIR. The inventive method will correct the discrepancy, and thereby it will increase throughput of the link.

Δ_{n,k}<<0 dB: The Tx-unit has over estimated the Rx-unit's actual SIR. The inventive method will try to level the discrepancy. This will effect the throughput in a positive way since there will be less retransmissions.

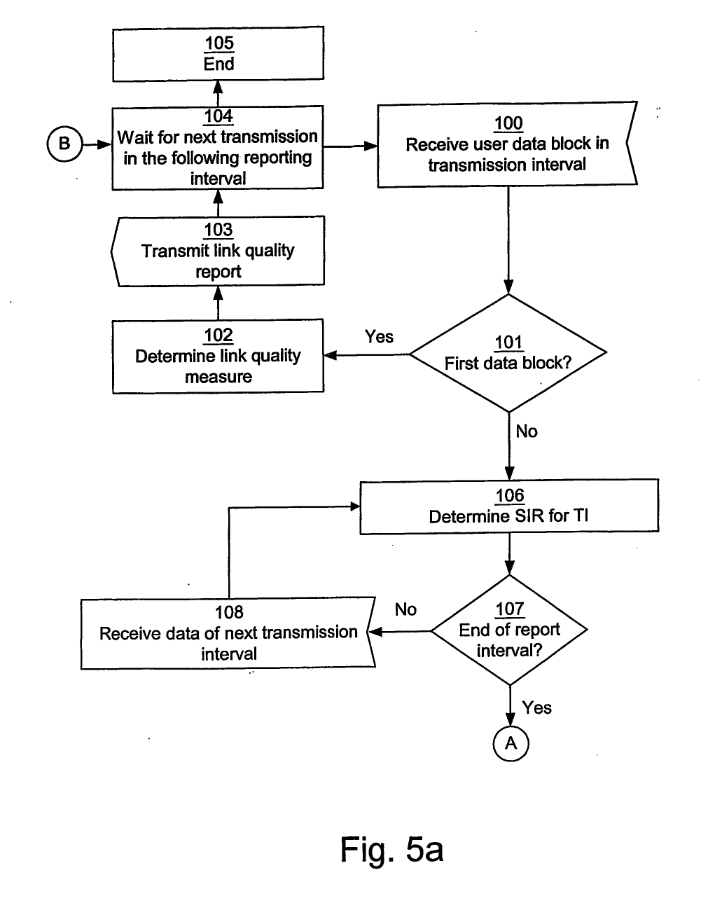

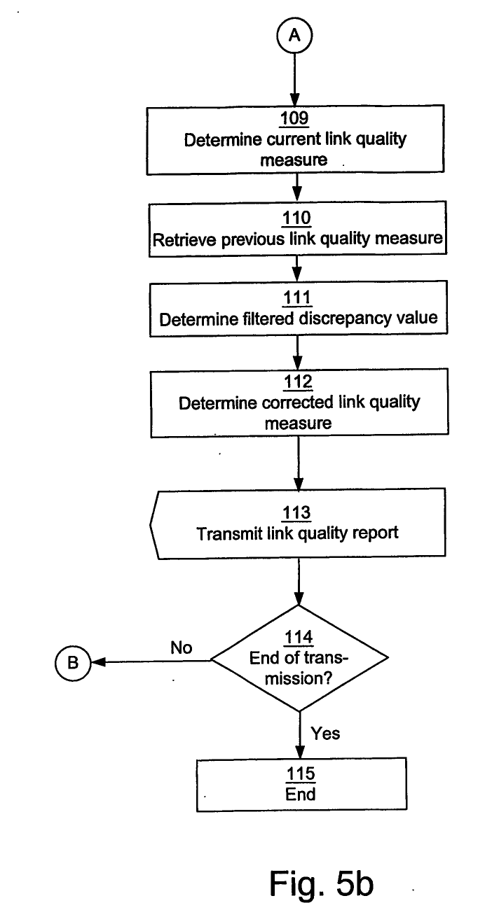

FIGS. 5a and 5b illustrate the steps carried out in the Rx-unit according to one embodiment of the inventive method, wherein SIR reporting is utilized for the link quality report and the discrepancy variable or SIR loss is filtered. The procedure starts in a first step 100, wherein a signal carrying a user data block in a transmission interval is received. Alternatively, a TFRC indicator signalled by the Tx-unit is received. Then, in step 101 it is decided whether the received data block is the first block that is received in a transmission session. If so, the procedure continues in step 102, wherein the first link quality measure is determined, i.e. the SIR value of the report interval as measured for the pilot channel. Then, in step 103 the link quality report, i.e. the value of the SIR determined in step 102, is transmitted to the Tx-unit. In step 104 the procedure waits until the next transmission of the subsequent reporting interval is received, wherein the procedure continues in step 100. If no more data blocks are received, the procedure ends in step 105.

If the answer in step 101 is no, the procedure continues in step 106, wherein the SIR value for the transmission interval is determined, by mapping the TFRC indicator received over the pilot channel, and temporarily stored. In step 107 it is determined whether the report interval is ended, i.e. whether the data of the last transmission interval of the reporting interval is received. If the answer in step 107 is no, the procedure continues in step 108, wherein the data of the next transmission interval is received. Then the procedure returns to step 106 to determine the SIR of the transmission interval received in step 108. When all transmission intervals of a reporting interval has been received, i.e. when the answer in step 107 is affirmative, the procedure continues in step 109, wherein the determination of the corrected link quality measure of the present reporting interval commences, i.e. the current SIR value of the reporting interval. In step 110, the link quality measure that formed basis of the previous reporting interval is retrieved from the memory. The link quality measure for the previous reporting interval together with the link quality measures of the transmission intervals of the current reporting interval, determined in step 106, are utilized in step 111 to determine the filtered discrepancy value, as described above. In step 112 the discrepancy value is added to the current link quality measure, i.e. the SIR value of the current reporting interval, to obtain the corrected link quality measure of the current reporting interval. Then, in step 113, the link quality report comprising the corrected link quality measure is transmitted to the Tx-unit. The procedure then continues in step 114 wherein it is determined whether the transmission session is ended, e.g. by determining that higher layer signaling has commenced. If the answer is affirmative, the procedure ends in step 115. If the answer in step 114 is no, the procedure continues in step 104, where the procedure waits until data of the next transmission interval is received.

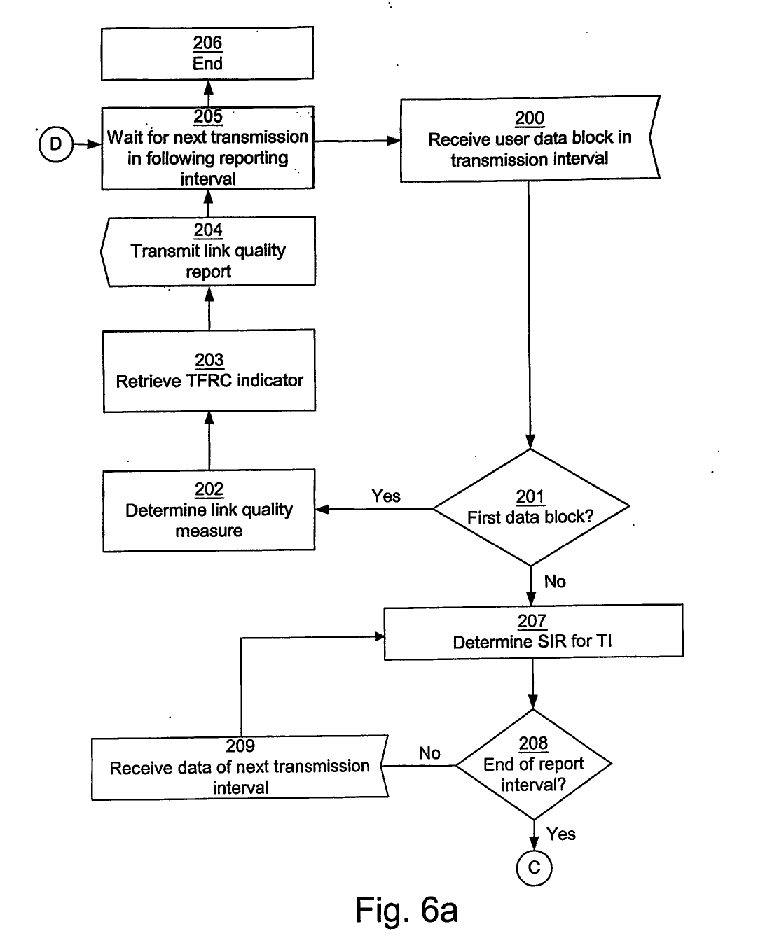

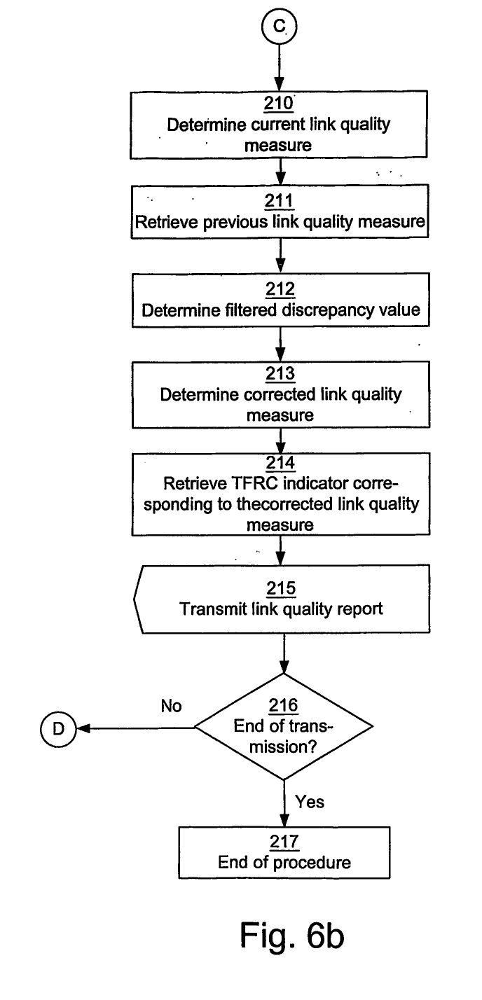

FIGS. 6a and 6b illustrate the steps carried out according to an alternative embodiment of the inventive method, wherein TFRC reporting is utilized and the discrepancy value is filtered. The procedure starts in step 200, wherein a user data block is received over the data channel, or a TFRC indicator is received. Then, in step 201 it is determined whether it is the first transmission interval of a transmission session. If so, the procedure continues in step 202, wherein a current link quality measure, such as a SIR value of the current reporting interval, is determined and temporarily stored for use in a later step. In step 203 the determined current link quality measure is utilized as an index to address the look-up table. The assumed user data size may also be used as an index to address the look-up table if several TFRC indicators having different user data sizes are stored for each SIR value. In step 204, the retrieved TFRC indicator is incorporated into the link quality report and transmitted to the Tx-unit. The procedure waits in step 205 until the next transmission interval of the subsequent reporting interval or a TFRC indicator is received, wherein the procedure continues in step 200, or ends in step 206 if no more data is received.

If the answer in step 201 is no, the procedure continues in step 207, wherein the SIR of the transmission interval is determined, by mapping the TFRC indicator received for that transmission interval, and temporarily stored. In step 208 it is determined whether the report interval is ended, i.e. whether the data of all transmission intervals is received. If the answer is no, the procedure continues in step 209, wherein the TFRC indicator and the data of the next transmission interval is received. Then, the procedure returns to step 207 to determine and store the SIR value of the transmission interval received in step 209. Consequently, step 209 is repeated until all transmission intervals of a reporting interval have been received. If the answer in step 208 is affirmative, the procedure continues in step 210, wherein the current link quality measure of the reporting interval, such as a SIR value, is determined. Then, in step 211 a temporarily stored link quality measure, which formed basis of the link quality report of the previous reporting interval, is retrieved from the memory. The stored link quality measure is either an uncorrected link quality measure, if only one link quality report has been transmitted to the Tx-unit during the transmission session, or the previous corrected link quality measure if at least one link quality report has been transmitted during the transmission session. In step 212 the filtered discrepancy value is determined, e.g. according to the principles as set out above. In step 213 the corrected link quality measure, i.e. a corrected SIR value, based on the SIR value of the current reporting interval and the filtered discrepancy value, is determined and stored for use in the next reporting interval. In step 214 the corrected link quality measure is utilized as an index to address the look-up table to retrieve the TFRC indicator corresponding to the corrected link quality measure, and possibly to an assumed user data size, as described in relation to step 203. The retrieved TFRC indicator is then in step 215 incorporated into the link quality report, which is transmitted to the Tx-unit. In step 216 it is determined whether the transmission session is ended. If so the procedure ends in step 217. Otherwise, the procedure proceeds to step 205, wherein the procedure waits for the next transmission interval of the next reporting interval.

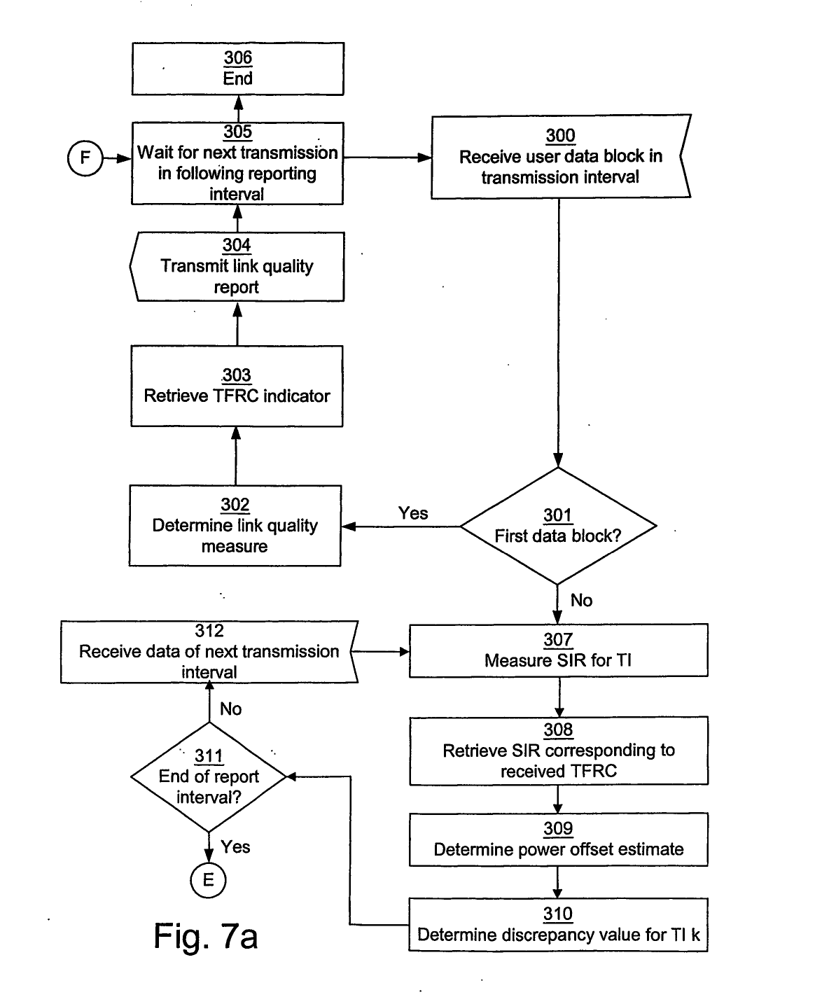

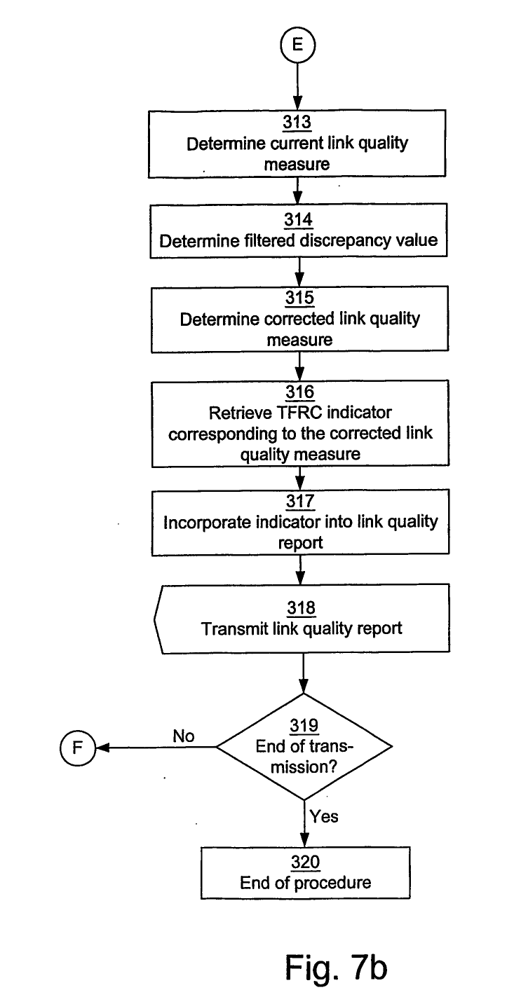

FIGS. 7a and 7b illustrates the steps of yet another embodiment of inventive method, wherein TFRC reporting is utilized and the discrepancy value is filtered. The procedure starts in step 300, wherein a user data block is received over the data channel, or a TFRC indicator is received. Then, in step 301 it is determined whether it is the first transmission interval of a transmission session. If so, the procedure continues in step 302, wherein a current link quality measure, such as a SIR value of the current reporting interval, is determined and temporarily stored for use in a later step. In step 303 the determined current link quality measure is utilized as an index to address the look-up table. Also, the assumed user data size may be used as an index to address the look-up table if several TFRC indicators having different user data sizes are stored for each SIR value. In step 304, the retrieved TFRC indicator is incorporated into the link quality report and transmitted to the Tx-unit. The procedure waits in step 305 until the next transmission interval of the subsequent reporting interval or a TFRC indicator is received, wherein the procedure continues in step 300, or ends in step 306 if no more data is received.

If the answer in step 301 is no, the procedure continues in step 307, wherein the SIR of the transmission interval is measured. In step 308 the TFRC indicator received for that transmission interval is used as an index to address the look-up table to retrieve a corresponding SIR value. In step 309, the estimate of the power offset between the pilot channel and the data channel is determined. In step 310 the information obtained in steps 307-309 is used to determine a discrepancy value or a SIR loss for transmission interval k of the current reporting interval. This value is then temporarily stored. In step 311 it is determined whether the report interval is ended, i.e. whether the data of all transmission intervals is received. If the answer is no, the procedure continues in step 312, wherein the data of the next transmission interval is received and the SIR of the transmission interval is determined in step 307. Consequently, steps 307-312 are repeated until all transmission intervals of a reporting interval have been received. If the answer in step 311 is affirmative, the procedure continues in step 313, wherein the current link quality measure of the reporting interval, such as a SIR value, is determined. In step 314 the filtered discrepancy value is determined based on the transmission interval discrepancy values obtained in step 310. In step 315 the corrected link quality measure, i.e. a corrected SIR value, based on the SIR value of the current reporting interval and the filtered discrepancy value, is determined. In step 316 the corrected link quality measure is utilized as an index to address the look-up table to retrieve the TFRC indicator corresponding to the corrected link quality measure, and possibly to an assumed user data size. The retrieved TFRC indicator is in step 317 incorporated into the link quality report, which is transmitted to the Tx-unit in step 318. In step 319 it is determined whether the transmission session is ended. If so the procedure ends in step 320. Otherwise, the procedure proceeds to step 305, wherein the procedure waits for the next transmission interval of the next reporting interval.

According to one application of the present invention the method for providing corrected link quality measures is provided in a WCDMA (Wideband Code Division Multiple Access) communication system, wherein HS-DSCH is one feature. The system provides, e.g. link adaptation, fast retransmissions and incremental redundancy. Link adaptation in HS-DSCH involves two modulation schemes, QPSK (Quadrature Phase Shift Keying) and 16 QAM (16 Quadrature Amplitude Modulation), up to 15 channelization codes per user, and 64 different data sizes (denoted transport block sizes in HS-DSCH) per modulation/code-channel combination. Further, the code rate is selected to fit one HS-DSCH transport block into the number of physical channel positions available during each transmission interval. The reported unit in an HS-DSCH is a downlink channel quality indicator, CQI, of which there are 124 different values. The CQI-values maps directly to 124 different TFRC indicators, of which there are 1920 in total. Although the 124 different CQI-values are chosen to cover the interesting SIR-range as efficiently as possible, there is about 1 dB spacing between the BLER curves, and a problem still remains with mismatching Tx-and Rx-characteristics when user data rates between reported and used TFRC do not match. Therefore, utilizing the present invention to correct the reported link quality measure will take care of the mismatch.

Hence, it is the transport block size N_{TrCH} together with the modulation scheme M and the number of channelization codes N_{c} that determine how large the look-up table mentioned above needs to be:

Nₑₙₜᵣᵢₑₛ=2 N_{c} N_{TrCH}=1920,

since N_{TrCH}=64 per M and N_{c} combination and N_{c}=15, where the factor 2 comes from two possible modulation schemes. Each of these entries needs to contain a SIR value with a certain resolution, e.g. 8 bits. The table would in that case consume about 2 kbyt of memory.

The method according to the invention can be comprised on a computer readable medium, such as the memory 33, having embodied thereon a computer program for processing by the mobile telephone (16, 17) having digital computer capabilities, such as the controller 35. The computer program will in such a case comprise code segment for carrying out the method according to the invention, such as described in relation to the above-disclosed embodiments.

The present invention has been described above with reference to specific embodiments. However, within the scope of the invention other embodiments than the ones described are equally possible. Different method steps than those described above, performing the method by hardware or software, may e.g. be provided within the scope of the invention. The different features and steps of the invention may be combined in other combinations than those described. The invention is only limited by the appended patent claims.

1. A method for providing link adaptation in a wireless communication system, comprising the steps of:
obtaining in a current link quality measure of a communication link;
determining a Signal-to-Interference Ratio (SIR) value of the communication link; and
correcting the current link quality measure based on the determined value.

2. The method according to claim 1, wherein the SIR value is determined in a receiving unit based on a SIR value induced by unmatched physical layer transmission parameter settings of a transmitting unit and a receiving unit.

3. The method according to claim 1, further comprising:
transmitting a link quality report being based on the corrected link quality measure.

4. The method according to claim 1, wherein obtaining the link quality measure comprises:
estimating for a reporting interval the SIR of a signal received over the communication link, said SIR is used to form the current link quality measure.

5. The method according to claim 1, wherein the discrepancy between desired transmission parameter settings and used transmission parameter settings is utilized to determine the SIR value.

6. The method according to claim 1, wherein a transmission parameter indicator for indicating the transmission parameters used for a subsequent transmission of data over a physical channel in a transmission interval is utilized for determining the SIR value of the transmission interval.

7. The method according to claim 6, wherein the transmission parameter indicator is used as an index to address a look-up table for retrieving a corresponding SIR value.

8. The method according to claim 7, wherein a discrepancy value is determined for the reporting interval, which is based on the difference between the SIR value retrieved from the look-up table and a previous SIR value that was used to form the previous link quality report, and the discrepancy value is added to the current link quality measure to form the corrected link quality measure.

9. The method according to claim 8, wherein the discrepancy value is a filtered discrepancy value, which is based on a SIR value of each transmission interval of a reporting interval and a previous SIR value that was used to form the previous link quality report.

10. The method according to claim 7, wherein a discrepancy value is determined for the reporting interval, which is based on a SIR estimation of a signal of a transmission interval transmitted over a pilot channel corrected for any power gain factor and the SIR value retrieved from the look-up table, and the discrepancy value is added to the current link quality measure to form the corrected link quality measure.

11. The method according to claim 10, wherein the power gain factor is estimated by determining the difference between the estimated SIR value of the pilot channel, and an estimated SIR value of a signal transmitted over the data channel.

12. The method according to claim 8, wherein the discrepancy value is a filtered discrepancy value, which is based on the discrepancy values determined for each transmission interval over a reporting interval.

13. The method according to claim 12, wherein the filtered discrepancy value is a mean value of the discrepancy values determined for each transmission interval over a reporting interval.

14. The method according to claim 1, further comprising:
mapping the corrected current link quality measure against transmission parameter indicators stored in a look-up table, wherein the corrected link quality measure is used to address said look-up table;
retrieving a transmission parameter indicator that matches the corrected link quality measure; and
incorporating the retrieved transmission parameter indicator into the link quality report.

15. The method according to claim 1, comprising:
mapping the corrected link quality measure together with a user data size value against transmission parameter indicators stored in a look-up table, wherein the corrected link quality measure and the user data size value are utilized to address the look-up table;
retrieving the transmission parameter indicator, which matches the corrected link quality measure and the user data size value; and
incorporating the retrieved transmission parameter indicator and the user data size value into the link quality report.

16. The method according to claim 1, further comprising:
incorporating the corrected link quality measure being a SIR value into the link quality report.

17. An electronic communication apparatus for supporting link adaptation of a communication link, comprising:
a receiver;
a transmitter unit;
a memory;
a measurement unit for determining a current link quality measure of a communication link;
a controller; and
a correction unit adapted to determine a SIR value of the communication link, and to correct the current link quality measure based on the determined value.

18. The apparatus according to claim 17, wherein the apparatus is adapted to:
estimate for a reporting interval the SIR of a signal received over the communication link; and
the correction unit is adapted to use said estimated SIR to form the current link quality measure.

19. The apparatus according to claim 17, wherein the apparatus is adapted to:
determine the discrepancy between desired transmission parameter settings and used transmission parameter settings; and
use said discrepancy to determine the SIR value.

20. The apparatus according to claim 17, wherein the apparatus is adapted to:
obtain a transmission parameter indicator, which indicates the transmission parameters used for a subsequent transmission of data in a transmission interval over a physical channel; and
determine a SIR value of the transmission interval based on the obtained transmission parameter indicator.

21. The apparatus according to claim 20, wherein the apparatus is adapted to:
use a transmission parameter indicator received over the communication link as an index to address a look-up table stored in the memory for retrieving a corresponding SIR value.

22. The apparatus according to claim 21, wherein the apparatus is adapted to:
determine a discrepancy value for the reporting interval, which is based on the difference between the SIR value retrieved from the look-up table and a previous SIR value that was used to form the previous link quality report; and
add the discrepancy value to the current link quality measure to form the corrected link quality measure.

23. The apparatus according to claim 22, wherein the apparatus is further adapted to:
filter the discrepancy value based on a SIR value of each transmission interval of a reporting interval and a previous SIR value that was used to form the previous link quality report.

24. The apparatus according to claim 21, the apparatus is adapted to:
determine a discrepancy value for the reporting interval, which is based on a SIR estimation of a transmission interval of a signal transmitted over a pilot channel corrected for any power gain factor and the SIR value retrieved from the look-up table; and
add the discrepancy value to the current link quality measure to form the corrected link quality measure.

25. The apparatus according to claim 24, wherein the apparatus is adapted to:
estimate the power gain factor by determining the difference between the estimated SIR value of the pilot channel, and an SIR value of a signal transmitted over the data channel.

26. The apparatus according to claim 24, wherein the apparatus is adapted to;
filter the discrepancy value based on the discrepancy values determined for each transmission interval of a reporting interval.

27. The apparatus according to any claim 17, wherein the apparatus is further adapted to:
map the corrected current link quality measure against transmission parameter indicators stored in a look-up table of the memory, wherein the corrected link quality measure is used to address the look-up table;
retrieve a transmission parameter indicator that matches the corrected link quality measure; and
incorporate the retrieved indicator into the link quality report.

28. The apparatus according to claim 17, wherein the apparatus is further adapted to:
map the corrected link quality measure together with a user data size value against transmission parameter indicators stored in a look-up table, wherein the corrected link quality measure and the user data size value are utilized to address the look-up table;
retrieve the transmission parameter indicator, which matches the corrected link quality measure and the user data size value; and
incorporate the retrieved transmission parameter indicator and the user data size value into the link quality report.

29. The apparatus according to claim 17, wherein the apparatus is further adapted to:
incorporate the corrected link quality measure being a SIR value into the link quality report.

30. The apparatus according to claim 17, wherein the apparatus is a mobile radio terminal, a pager or a communicator.

31. The apparatus according claim 17, wherein the apparatus is a mobile telephone.

32. A computer program product directly loadable into the memory of a mobile terminal having digital computer capabilities, comprising software code portions for performing the following steps of when said product is run by said mobile terminal:
obtaining in a current link quality measure of a communication link;
determining a Signal-to-Interference Ratio (SIR) value of the communication link; and
correcting the current link quality measure based on the determined value.
